(19) United States
(12) Patent Application Publication
(10) Pub. No.: US 2024/0001895 A1
(43) Pub. Date: Jan. 4, 2024

(54) Effective Control of Wheel Slip in an Electrically Powered Utility Vehicle

(71) Applicant: KNORR-BREMSE Systeme fuer Nutzfahrzeuge GmbH, Muenchen (DE)

(72) Inventor: Daniel THUM, Stuttgart (DE)

(21) Appl. No.: 18/035,136

(22) PCT Filed: Oct. 15, 2021
(86) PCT No.: PCT/EP2021/078633

§ 371 Date: May 3, 2023

(30) Foreign Application Priority Data
Nov. 4, 2020 (DE) 10 2020 213 878.8

(51) Int. Cl. B60T 8/1761; B60T 8/172

(52) U.S. Cl. CPC B60T 8/17616; B60T 8/172

(57) ABSTRACT

A control method and device are provided for a commercial vehicle brake system, wherein brake slip can be adjusted by at least one electric motor and at least one further brake, such as a pneumatic service brake. In the event of a normal braking request, deceleration is realized solely by at least one electric motor, and if a deceleration request exceeds the potential of the at least one electric motor or the brake slip becomes too high, the calculated braking torque is correspondingly distributed to the at least one electric motor and a further brake, such as a pneumatic service brake. As the responsiveness and controllability of electric drive motors are considerably better than pneumatic brake systems, these advantages are correspondingly utilized in the present braking method and the present braking device.

### BACKGROUND AND SUMMARY

The present invention relates to a control method and a control device for brake systems of commercial vehicles.

Commercial vehicles usually have pneumatic brake systems. When braking occurs in commercial vehicles, compressed air is fed into a brake cylinder. At the end of the braking process, this is again withdrawn from the compressed air brake cylinder.

Brake systems for commercial vehicles usually also have anti-lock brake systems (ABS). An anti-lock brake system counteracts a possible locking of the wheels by reducing the brake pressure during a braking process, i.e. the introduction of compressed air into a brake cylinder. In particular, this improves steerability and directional stability during braking. Furthermore, an anti-lock brake system can regulate the wheel brake slip and thus shorten the braking distance on wet roads.

Braking using the anti-lock braking function usually leads to high air consumption, as the brake cylinders are continuously ventilated and vented at short intervals. This limits the availability of the complete brake system functionality.

Another important parameter for braking a commercial vehicle is the stability of a commercial vehicle during braking. This is ensured by adjusting the brake slip. The more accurately the brake slip can be adjusted, the higher the braking deceleration can be, which in turn improves stability.

However, pneumatic control of brake slip entails physical limitations. Due to the compressibility of air, the speed of movement of the air medium is low, which leads to problems with controllability and reduced accuracy of the brake. Furthermore, the response speed of the brake and thus the deceleration in the vehicle is low.

A utility vehicle with an internal combustion engine usually has at least one wear-free brake system such as an engine brake or a hydrostatic retarder.

In the case of commercial vehicles with electric drives, the wear-free brake system is covered by recuperation by the electric powertrain.

In addition, according to the prior art, commercial vehicles have a friction brake, the so-called service brake. When braking is initiated, the deceleration potential of the wear-free brake system is exploited first. If the deceleration request exceeds the potential of the wear-free brake, the brake system is actuated and contributes to part of the braking effect.

If a defined brake slip limit is reached on a wheel (locking of a wheel) during a deceleration process, in the prior art the further deceleration is adjusted solely by the pneumatic service brake. The reason for this is that retarders and the engine brake cannot be trusted during safety-critical braking or that they can only be controlled to a limited extent.

It is therefore an object of the present invention to provide a braking method and a braking device with which physical limitations in the control of the brake slip can be eliminated and improved controllability and improved accuracy of the brake can be achieved. Another object of the present invention is to minimize the response speed of the brake, the braking distance and the deceleration of the vehicle.

This object is achieved by a control method for the brakes of a commercial vehicle and a control device in accordance with the independent claims.

A control method according to the invention for braking a commercial vehicle which comprises at least one electric motor includes the following steps:
(a) receiving a deceleration request by a brake system, which may be a centralized or decentralized brake system;
(b) calculation of at least one braking torque by a control device;
(c) generating the braking torque calculated in step (b) by at least one electric motor;
(d) repeated detection of the brake slip on at least one wheel (R) of the commercial vehicle;
(e) if the brake slip of a wheel determined in step (d) reaches a predetermined stability-critical limit or if the braking torque calculated in step (b) exceeds the maximum braking torque of the electric motor: distribute the braking torque calculated in step (b) to at least one electric motor and at least one other brake.

The at least one other brake may be, for example, a pneumatic service brake, an electromechanical brake or a retarder.

Preferably, the braking torque is determined on each wheel by the control device. The brake slip is also preferably determined on each wheel.

The responsiveness of the controllability of electric drives is significantly better than that of a pneumatic brake system, i.e. a service brake, and the adjustment of the wheel brake slip is therefore mainly done with the electric motor. Therefore, the deceleration is first implemented purely with the at least one electric motor. Only when the deceleration request exceeds the braking capacity of the electric motor or when the brake slip of the wheels reaches a stability-critical limit, is the calculated braking torque distributed to the at least one further brake, such as a pneumatic service brake, and the at least one electric motor, i.e. braking with at least one other brake is carried out in parallel with braking by the at least one electric motor.

According to one embodiment, the braking torque is calculated individually per wheel, and in step c) the braking torque is generated by at least one electric motor assigned to a wheel. The additional brake, such as a pneumatic service brake, builds up a constant basic braking torque if required, which is important for stable braking. The electric motor undertakes the fine control in the ABS case.

According to the first embodiment, the brake slip of at least one wheel of the commercial vehicle is further preferably controlled with at least one electric motor which is assigned to a wheel (preferably to a plurality of wheels or each wheel). On the one hand, this allows the brake slip to be adjusted more precisely, as an electric motor responds faster than another brake such as a pneumatic brake, and thus the braking distance of the vehicle can be reduced. On the other hand, the braking potential is not restricted or at least is less restricted for subsequent braking processes, since only a little air is consumed during braking (since the at least one other brake, such as a pneumatic service brake, is only responsible for producing a basic braking torque).

In a second embodiment, in step b) the braking torque is calculated wheel-specifically, but in step c) the braking torque is generated by at least one electric motor assigned to an axle. During braking, the braking torque is distributed to the axle brake, i.e. the electric motor, and, if necessary, to at least one other brake such as a service brake.

Further preferably, in the second embodiment, the brake slip on at least one wheel of the commercial vehicle is then controlled with the at least one other brake such as a service brake, if necessary. If the required braking torque can be generated by the electric motor, the service brake is not required, because if the braking torques set at the deceleration are the same and can be covered by the axle-specific electric motor alone, no intervention of the other brake such as a service brake is necessary. The axle-specific electric motor always sets the smallest required torque for its axle, provided that the electrically available drive torque allows it. The additional wheel torque or the fine adjustment of the brake slip on the wheel in the ABS case is carried out if necessary by means of the at least one other brake, such as the pneumatic service brake system.

As a result, the air consumption during braking is reduced and the braking capacity is not restricted or is less restricted for subsequent braking. Since most of the braking is carried out by the electric motor and only the fine adjustment of the brake slip is carried out by the at least one other brake such as a service brake, air consumption can be minimized accordingly.

A control device according to the invention for the control of a brake system of a commercial vehicle is set up to calculate at least one braking torque and to generate it by at least one electric motor, wherein the control device is further set up to repeatedly determine the brake slip on at least one wheel of the commercial vehicle, and if the determined brake slip reaches a predetermined stability-critical limit value or if the calculated braking torque exceeds the maximum braking torque of the electric motor, to distribute the calculated braking torque to the at least one electric motor and at least one other brake.

Preferably, the calculation of the braking torque is carried out wheel-specifically or axle-specifically. In the axle-specific case, it is checked whether there are axle-specific similarities so that the electric motor (in the axle-specific case) can undertake part of the braking torque

In the first embodiment, with wheel-specific control, the braking torque is calculated on a wheel-specific basis and then generated by each electric motor assigned to a wheel, wherein the brake slip on at least one wheel of the commercial vehicle is finely controlled with the at least one electric motor.

In the second embodiment, when the braking torque is calculated axle-specifically, the braking torque is generated by each electric motor assigned to an axle, and the brake slip on at least one wheel of the vehicle is finely controlled with the other brake, such as a pneumatic service brake, if there are different braking torques.

During the brake control, care must be taken in the axle-specific case to ensure that no unwanted brake slip or traction slip can occur due to the revolution rate transfer of the differential. This is taken into account when calculating the braking torque and implemented accordingly by the drive control system. The maintenance of the revolution rates is carried out according to the following equation:

n₁−i₀·n₂−(1−i₀)·nₛ=0

wherein n₁ and n₂ are the revolution rates of the driven vehicle wheels and nₛ is the revolution rate of the ring gear of the transmission and thus the drive shaft or cardan shaft. In this case, i₀ is the standard ratio for normal vehicle operation.

In the following, preferred embodiments of the present invention are explained in more detail with reference to the accompanying figures.

### BRIEF DESCRIPTION OF THE DRAWINGS

FIG. 1 is a graph showing a braking process according to a first embodiment of the present invention, in which a wheel-specific electric drive is provided, i.e. in which there is an electric motor per wheel.

FIG. 2 is a graph showing a braking process according to a second embodiment of the present invention, in which an axle-specific electric drive is provided, i.e. in which there is an electric motor per axle.

### DETAILED DESCRIPTION OF THE DRAWINGS

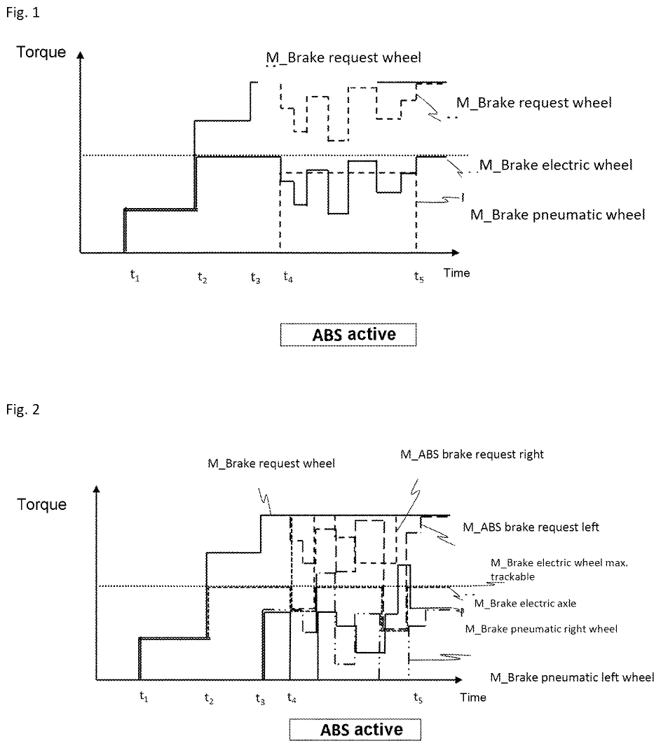

In FIG. 1, several braking torques are plotted against time. Up to time t₁ there is no braking request for the corresponding wheel, so there is no braking torque acting to meet the braking request (M_{Brake request wheel}). This braking torque to meet the braking request (M_{Brake request wheel}) increases abruptly at time t₁, remains the same until time t₂, and increases further from time t₂. The braking torque to achieve the braking request (M_{Brake request wheel}) remains the same up to time t₃, and then rises again abruptly. In FIG. 1 it is further shown that at time t₁ the braking torque of the electric motor (M_{Brake electric wheel}) on a wheel increases, remains the same until time t₂, at time t₂ increases again abruptly, but only up to the maximum available braking torque of the electric motor for the corresponding wheel (M_{Brake electric wheel max. available}). Up to time t₄, the braking torque of the electric motor for the wheel remains at the same level. However, since the required braking torque per wheel (M_{Brake request wheel}) is greater than the maximum braking torque that the electric motor can provide (M_{Brake electric wheel max. available}), from time t₄ an additional braking torque per wheel is provided by the pneumatic service brake. (M_{Pneumatic wheel brake}). This is generated up to time t₅. This is constant between the times t₄ and t₅, and thus covers a constants basic braking torque. Between the times t₄ and t₅, however, a predetermined stability-critical limit for the brake slip is exceeded (ABS case), which is why the electric motor E modulates its generated braking torque (M_{Brake electric wheel}) accordingly and always changes it gradually—but at most up to the maximum braking torque that the electric motor can apply (M_{Brake electric wheel max. available}). Accordingly, the braking request for the wheel and thus the ABS braking torque to achieve the braking request (M_{ABS brake request}) changes. After the brake slip has again fallen below a predetermined stability-critical limit value (time t₅), the anti-lock brake system is no longer active, and the pneumatic braking torque due to the service brake (M_{Pneumatic wheel brake}) can be reduced accordingly. The braking torque applied to a wheel by the electric motor (M_{Brake electric wheel}) rises again to its maximum value (M_{Brake electric wheel max. available}).

In FIG. 2, the axle-specific control of the electric drive is shown. The braking torque, which must act to meet a braking request (M_{Brake request wheel}), is similar to FIG. 1. Also m the maximum braking torque, which can be generated at an electric motor per wheel (M_{Brake electric wheel max. available}), is similar to FIG. 1. This shows, however, that from time t₃ the braking torques of the electric motor (M_{Brake electric axle}) and the service brake (M_{Brake pneumatic right wheel}, M_{Pneumatic brake left wheel}) behave correspondingly differently. The electrically generated braking torque on the axle (M_{Brake electric axle}) is largely constant, with two small drops. From the time t₄, when a certain stability-critical limit is exceeded, the brake slip must be controlled. For this purpose, the ABS braking torques on two wheels (M_{ABS brake request right}, M_{ABS brake request} left) are modulated and the two braking torques of the service brake on the right wheel (M_{Brake pneumatic right wheel}) and on the left wheel (M_{Brake pneumatic left wheel}) are correspondingly regulated, as they are responsible for the fine adjustment of the brake slip. From time is onwards, the electric motor mainly regulates the brake system again.

The present invention relates to a control method and a control device for brake systems for commercial vehicles, wherein brake slip can be adjusted here both by at least one electric motor and at least one other brake such as a pneumatic service brake. A deceleration for a normal braking request is implemented purely with at least one electric motor, and if a deceleration request exceeds the potential of the at least one electric motor or the brake slip becomes too great, the calculated braking torque is distributed accordingly to the at least one electric motor and another brake such as a pneumatic service brake. Since the responsiveness and controllability of electric drives are significantly better than those of pneumatic brake systems, these advantages are exploited accordingly in the present braking method and in the present brake device.

1.-9. (canceled)

10. A control method for braking a commercial vehicle, comprising:
(a) receiving a deceleration request by a brake system;
(b) calculating at least one braking torque by a control device;
(c) generating the braking torque calculated in step (b) by the at least one electric motor of the commercial vehicle;
(d) repeatedly detecting brake slip on at least one wheel of the commercial vehicle;
(e) when the brake slip of a wheel determined in step (d) reaches a predetermined stability-critical limit value or when the braking torque calculated in step (b) exceeds the maximum braking torque of the electric motor, distributing the braking torque calculated in step (b) to the at least one electric motor and at least one other brake.

11. The control method as claimed in claim 10, wherein
in step (b), the braking torque is calculated wheel-specifically, and
in step (c), the braking torque is generated by at least one electric motor assigned to a wheel.

12. The control method as claimed in claim 10, further comprising:
(f) controlling the brake slip on at least one wheel of the commercial vehicle with the at least on electric motor.

13. The control method as claimed in claim 10, wherein
in step (b), the braking torque is calculated wheel-specifically, and
in step (c), the braking torque is generated by at least one electric motor assigned to an axle.

14. The control method as claimed in claim 10, further comprising:
(f) controlling the brake slip on at least one wheel of the commercial vehicle with the at least one other brake, if necessary.

15. A device for control of a brake system of a commercial vehicle having at least one electric motor, comprising:
a control device configured to calculate at least one braking torque and to generate said at least one braking torque by the at least one electric motor, wherein
the control device is further configured to:
repeatedly determine the brake slip on at least one wheel of the commercial vehicle, and
when the determined brake slip reaches a predetermined stability-critical limit value or when a necessary braking torque exceeds the maximum braking torque of the electric motor, distribute the calculated braking torque to the at least one electric motor and at least one other brake.

16. The device as claimed in claim 15, wherein
the calculation of the braking torque is carried out wheel-specifically or axle-specifically.

17. The device as claimed in claim 15, wherein
the control device is configured to determine the braking torque wheel-specifically and to generate the braking torque by each electric motor assigned to a wheel, wherein the brake slip on at least one wheel of the commercial vehicle is controlled with the at least one electric motor.

18. The device as claimed in claim 15, wherein
the control device is configured to determine the braking torque axle-specifically and to generate the braking torque by each electric motor assigned to an axle, wherein the brake slip on at least one wheel of the commercial vehicle is controlled with the at least one other brake.
